(19) United States
(12) Patent Application Publication
(10) Pub. No.: US 2022/0190617 A1
(43) Pub. Date: Jun. 16, 2022

(54) Power Tool External Power Supply Assembly

(71) Applicant: Kenneth Roberts, Fullerton, CA (US)

(72) Inventor: Kenneth Roberts, Fullerton, CA (US)

(21) Appl. No.: 17/123,817

(22) Filed: Dec. 16, 2020

(51) Int. Cl. H02J 7/00; H02M 3/04; H02M 7/04

(52) U.S. Cl. CPC H02J 7/0068; H02M 7/04; H02M 3/04

(57) ABSTRACT

A power tool external power supply assembly for reducing weight and increasing run time of a power tool includes a backpack positionable upon a user. A battery, which is rechargeable, is positioned in the backpack. A power cord is operationally engaged to and extends from the battery through a hole in the backpack. A connector engaged to the power cord distal from the battery can be engaged to a direct current powered device, such as a power tool, so that the battery is operationally engaged thereto. The battery can power the direct current powered device without the user having to support a mass of the battery in a hand along with the direct current powered device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to power supply assemblies and more particularly pertains to a new power supply assembly for reducing weight and increasing run time of a power tool. The present invention discloses a power supply assembly comprising a backpack having a battery positioned therein, wherein the battery is selectively operationally engageable to a variety of tools.

### (2) Description of Related Art Including Information Disclosed Under 37 CFR 1.97 and 1.98

The prior art relates to power supply assemblies. Prior art power supply assemblies may comprise holsters, vests and belts having one or more batteries engaged thereto for supplying alternating current or direct current to tools. The prior art also may comprise connectors for adapting tools to connect to remotely positioned batteries, and ac-dc converters for supplying alternating current to tools. What is lacking in the prior art is a power supply assembly comprising a backpack having a battery positioned therein, wherein the battery is selectively operationally engageable to a variety of tools.

### BRIEF SUMMARY OF THE INVENTION

An embodiment of the disclosure meets the needs presented above by generally comprising a backpack configured to selectively engage a user so that the backpack is removably engaged to the user. A battery, which is rechargeable, is positioned in the backpack. A power cord is operationally engaged to and extends from the battery through a hole in the backpack. A connector engaged to the power cord distal from the battery is configured to engage a direct current powered device, such as a power tool, so that the battery is operationally engaged thereto. The battery thus is configured to power the direct current powered device without the user having to support a mass of the battery in a hand along with the direct current powered device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a power tool external power supply assembly according to an embodiment of the disclosure.

FIG. 2 is a front view of an embodiment of the disclosure.

FIG. 3 is a back view of an embodiment of the disclosure.

FIG. 4 is a detail view of an embodiment of the disclosure.

FIG. 5 is a block diagram view of an embodiment of the disclosure.

FIG. 6 is an in-use view of an embodiment of the disclosure.

### DETAILED DESCRIPTION OF THE INVENTION

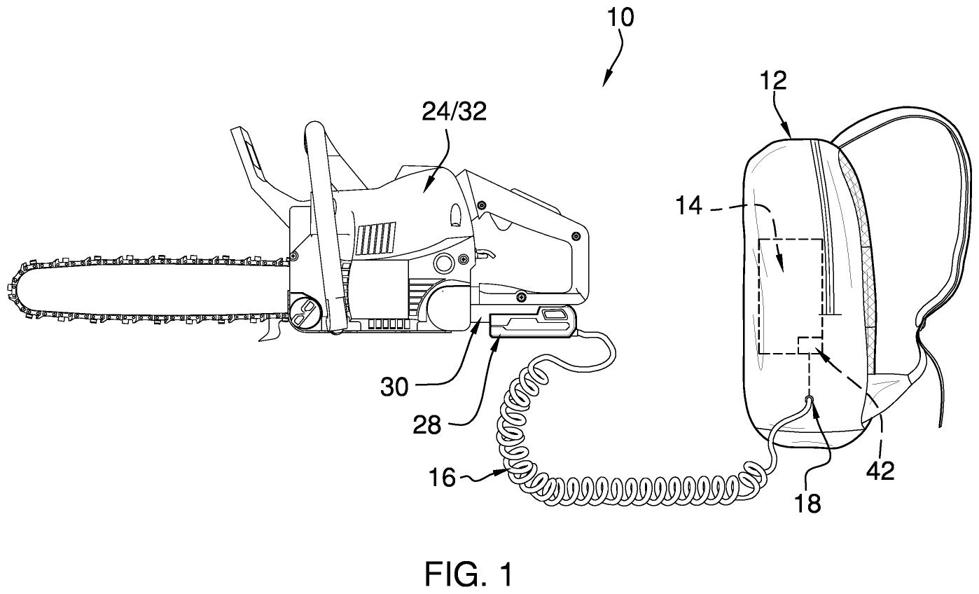

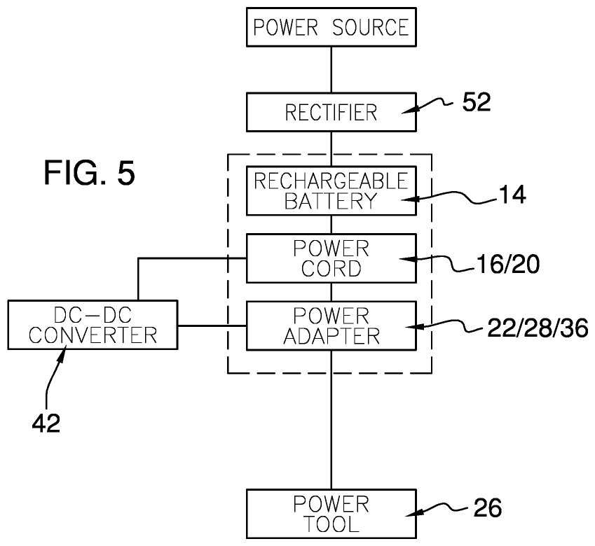

With reference now to the drawings, and in particular to FIGS. 1 through 6 thereof, a new power supply assembly embodying the principles and concepts of an embodiment of the disclosure and generally designated by the reference numeral 10 will be described.

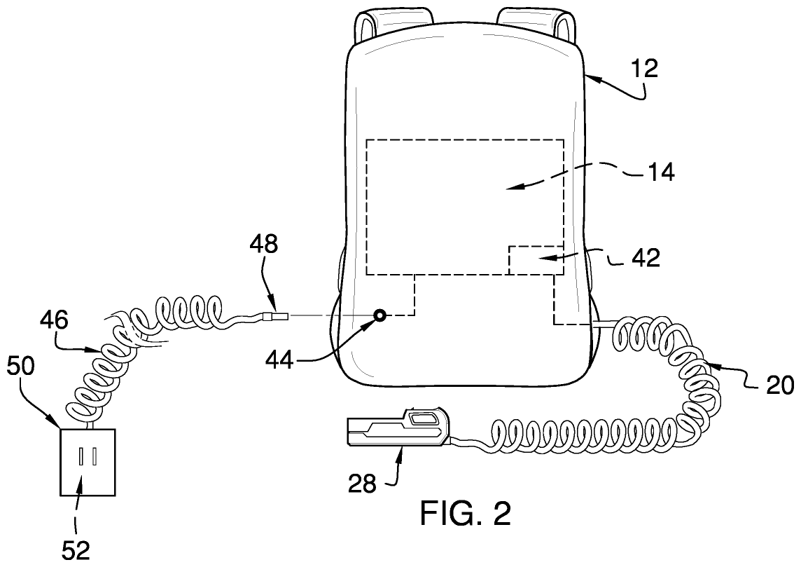

As best illustrated in FIGS. 1 through 6, the power tool external power supply assembly 10 generally comprises a backpack 12 configured to selectively engage a user so that the backpack 12 is removably engaged to the user. A battery 14, which is rechargeable, is positioned in the backpack 12. A power cord 16 is operationally engaged to and extends from the battery 14 through a hole 18 in the backpack 12. The power cord 16 may comprise a retractile coil cord 20, as shown in FIG. 2, or other cord type, such as, but not limited to, retractable cord reels, nonretractable cords, and the like.

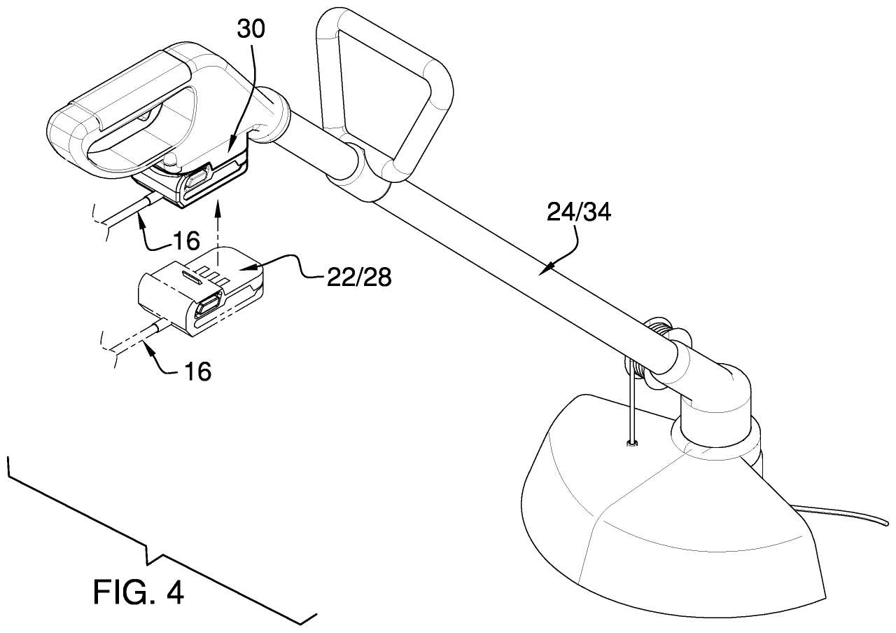

A connector 22 engaged to the power cord 16 distal from the battery 14 is configured to engage a direct current powered device 24, such as a power tool 26, so that the battery 14 is operationally engaged thereto. The connector 22 may comprise an adapter 28 configured to engage a battery mount 30 of the direct current powered device 24, as shown in FIG. 1, wherein the battery 14 is operationally engaged to a chainsaw 32, or as shown in FIG. 4, wherein the is operationally engaged to a weed trimmer 34.

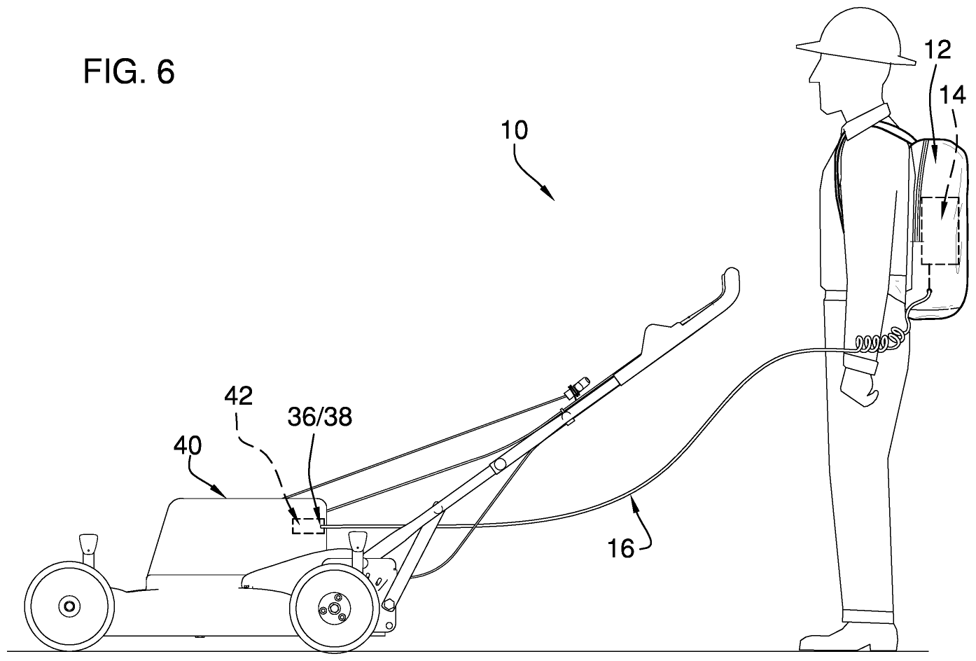

The connector 22 also may comprise a power plug 36 configured for insertion into a power port 38 of the direct current powered device 24, as shown in FIG. 6, wherein the battery 14 is operationally engaged to a lawn mower 40. The present invention anticipates the direct current powered device 24 comprising a broad range of power tools 26, in addition to those shown in FIGS. 1, 4, and 6, such as, but not limited to, drills, sanders, circular saws, nail guns, staplers, and the like.

The present invention also anticipates the connector 22 being removably engageable to the power cord 16 (not shown). As such, a respective adapter 28 complementary to a battery mount 30 of a particular direct current powered device 24 could be engaged to the power cord 16 and to the battery mount 30 to operationally engage the direct current powered device 24 to the battery 14.

The battery 14 thus is configured to power the direct current powered device 24 without the user having to support a mass of the battery 14 in a hand along with the direct current powered device 24. The battery 14 being separate from the direct current powered device 24 reduces fatigue, which also may reduce incidence of mistakes in utilizing the direct current powered device 24 that can result in injuries and damage to work products. The battery 14 can be sized such that it provides for increased operational times for the direct current powered device 24.

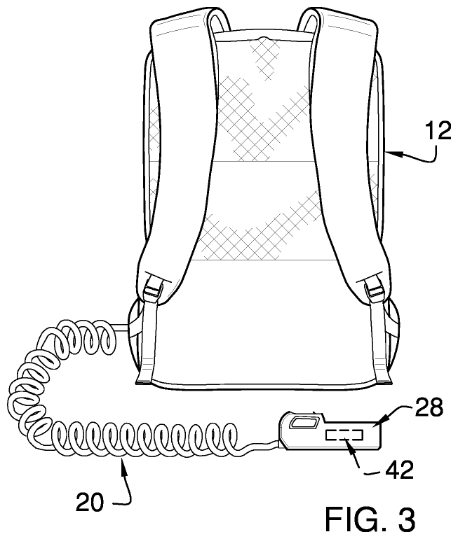

The assembly 10 also may comprise a DC-to-DC converter 42, which is operationally engaged to the battery 14. The DC-to-DC converter 42 is positioned to convert an output voltage from the battery 14 into an input voltage matching a voltage requirement for the direct current powered device 24. The DC-to-DC converter 42 may be positioned in the backpack 12, as shown in FIGS. 1 and 2, or in the adapter 28, as shown in FIG. 3. The DC-to-DC converter 42 also may be integral to the direct current powered device 24, as shown in FIG. 6.

A connection port 44 is engaged to the backpack 12 and is operationally engaged to the battery 14. A power cable 46 comprises a first plug 48, which is selectively engageable to the connection port 44. The power cable 46 comprises a second plug 50, which is selectively engageable to a source of electrical current, such as a standard wall outlet, so that the source of electrical current is operationally engaged to the battery 14 for charging thereof. The battery 14 thus can be charged without removing it from the backpack 12.

The present invention also anticipates the connection port 44 being directly engaged to the battery 14. As such, the battery 14 could be removed for charging, or the power cable 46 could be extended into the backpack 12 to charge the battery 14. The power cable 46 also may comprise a rectifier 52, which is configured to convert alternating current to direct current.

In use, the power cable 46 is used to charge the battery 14. The backpack 12 then can be donned by the user so that the mass of the battery 14 is supported on a back of the user, rather than in their hand. The adapter 28 is engaged to the battery mount 30 of the power tool 26, or the power plug 36 is inserted into the power port 38 of the power tool 26, so that the battery 14 is positioned to power the power tool 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

1. A power tool external power supply assembly comprising:
a backpack configured to selectively engage a user, such that the backpack is removably engaged to the user, the backpack having a top, a bottom, a front, a back, and a pair of lateral sides, each of said lateral sides having a flat outer surface;
a battery positioned in the backpack, the battery being rechargeable;
a power cord operationally engaged to and extending from the battery through a hole in one of the lateral sides of the backpack at a position closer to the bottom of the backpack than the top of the backpack; and
a connector engaged to the power cord distal from the battery, the connector being configured for engaging a direct current powered device, such that the battery is operationally engaged thereto, wherein the battery is configured for powering the direct current powered device.

2. The power tool external power supply assembly of claim 1, wherein the power cord comprises a retractile coil cord.

3. The power tool external power supply assembly of claim 1, wherein the connector comprises an adapter configured for engaging a battery mount of the direct current powered device or a power plug configured for insertion into a power port of the direct current powered device.

4. The power tool external power supply assembly of claim 3, further including a DC-to-DC converter operationally engaged to the battery, such that the DC-to-DC converter is positioned for converting an output voltage from the battery into an input voltage matching a voltage requirement for the direct current powered device.

5. The power tool external power supply assembly of claim wherein the DC-to-DC converter is positioned in the backpack or the adapter, or is integral to the direct current powered device.

6. The power tool external power supply assembly of claim 1, further including:
a connection port engaged to the backpack and operationally engaged to the battery; and
a power cable comprising a first plug selectively engageabie to the connection port and a second plug selectively engageable to a source of electrical current, such that the source of electrical current is operationally engaged to the battery for charging thereof.

7. The power tool external power supply assembly of claim 6, wherein the power cable comprises a rectifier configured for converting alternating current to direct current.

8. A power tool external power supply system comprising:
a power tool;
a backpack configured to selectively engage a user, such that the backpack is removably engaged to the user, the backpack having a top, a bottom, a front, a back, and a pair of lateral sides, each of said lateral sides having a flat outer surface;
a battery positioned in the backpack, the battery being rechargeable;
a power cord operationally engaged to and extending from the battery through a hole in one of the lateral sides of the backpack at a position closer to the bottom of the backpack than the top of the backpack the backpack; and
a connector engaged to the power cord distal from the battery, the connector being positioned for engaging the power tool, such that the battery is operationally engaged thereto, such that the battery is positioned for powering the power tool.

9. The power tool external power supply system of claim 8, wherein the power cord comprises a retractile coil cord.

10. The power tool external power supply system of claim 8, wherein the connector comprises an adapter positioned for engaging a battery mount of the power tool or a power plug positioned for insertion into a power port of the power tool.

11. The power tool external power supply system of claim 10, further including a DC-to-DC converter operationally engaged to the battery, such that the DC-to-DC converter is positioned for converting an output voltage from the battery into an input voltage matching a voltage requirement for the power tool.

12. The power tool external power supply system of claim 11, Wherein the DC-to-DC converter is positioned in the backpack or the adapter, or is integral to the power tool.

13. The power tool external power supply system of claim 8, further including:
a connection port engaged to the backpack and operationally engaged to the battery; and
a power cable comprising a first plug selectively engageable to the connection port and a second plug selectively engageable to a source of electrical current, such that the source of electrical current is operationally engaged to the battery for charging thereof.

14. The power tool external power supply system of claim 13, wherein the power cable comprises a rectifier configured for converting alternating current to direct current.

15. A power tool external power supply assembly comprising:
a backpack configured to selectively engage a user, such that the backpack is removably engaged to the user, the backpack having a top, a bottom, a front, a back, and a pair of lateral sides, each of said lateral sides having a flat outer surface;
a battery positioned in the backpack, the battery being rechargeable;
a power cord operationally engaged to and extending from the battery through a hole in one of the lateral sides of the backpack at a position closer to the bottom of the backpack than the top of the backpack the backpack, the power cord comprising a retractile coil cord;
a connector engaged to the power cord distal from the battery, the connector being configured for engaging a direct current powered device, such that the battery is operationally engaged thereto, wherein the battery is configured for powering the direct current powered device, the connector comprising an adapter configured for engaging a battery mount of the direct current powered device or a power plug configured for insertion into a power port of the direct current powered device;
a DC-to-DC converter operationally engaged to the battery, such that the DC-to-DC converter is positioned for converting an output voltage from the battery into an input voltage matching a voltage requirement for the direct current powered device, the DC-to-DC converter being positioned in the backpack or the adapter, or being integral to the direct current powered device;
a connection port engaged to the backpack and operationally engaged to the battery; and
a power cable comprising a first plug selectively engageabie to the connection port and a second plug selectively engageable to a source of electrical current, such that the source of electrical current is operationally engaged to the battery for charging thereof, the power cable comprising a rectifier configured for converting alternating current to direct current.
